(19) United States
(12) Patent Application Publication
(10) Pub. No.: US 2023/0108482 A1
(43) Pub. Date: Apr. 6, 2023

(54) SYSTEM AND METHOD FOR LARGE-SCALE ACCELERATED PARALLEL PREDICTIVE MODELLING AND CONTROL

(71) Applicant: Yum Connect, LLC, Louisville, KY (US)

(72) Inventors: Rockford Yost, Plano, TX (US); Ankur Gahlot, Plano, TX (US); Nikhil Jain, Plano, TX (US)

(21) Appl. No.: 17/936,784

(22) Filed: Sep. 29, 2022

Related U.S. Application Data
(60) Provisional application No. 63/250,898, filed on Sep. 30, 2021.

(51) Int. Cl. G06N 3/04; G06K 9/62; G06F 9/445

(52) U.S. Cl. CPC G06N 3/04; G06K 9/6257; G06F 9/44505

(57) ABSTRACT

A method for parallel predictive modelling includes receiving a configuration file associated with a predictive concept at a production layer of a predictive modelling platform, the predictive modelling platform comprising the production layer and a consumption layer connected by a distributed messaging system. The method further includes identifying, by the production layer, a job request based on the configuration file, sending the job request to the consumption layer as one of a plurality of job requests to be passed to a predictive model implemented by a processing container, wherein the predictive model is specified by the configuration file, obtaining, from the processing container, a forecast as an output of the predictive model, sending, by the distributed messaging system, the forecast to the production layer and determining, by the production layer, one or more values of the predictive concept based on the forecast and an operator specified by the configuration file.

### CROSS-REFERENCE TO RELATED APPLICATION AND CLAIM OF PRIORITY

This application claims priority under 35 U.S.C. § 119(e) to U.S. Provisional Patent Application No. 63/250,898 filed Sep. 30, 2021, the contents of which are incorporated by reference in their entirety herein.

### TECHNICAL FIELD

This disclosure relates generally to large-scale computing and computational architectures for large-scale implementations of deep learning techniques. Specifically, this disclosure relates to a system and method for large-scale accelerated parallel predictive modeling and control.

### BACKGROUND

Improvements in artificial intelligence (AI) and machine learning (ML), including the advent of machine learning networks with large numbers of layers and back propagation between layers (sometimes referred to as “deep learning models”), along with concomitant improvements in the ability to pool processing resources (for example, through cloud computing platforms such as AMAZON WEB SERVICES), have enabled computing platforms implementing AI/ML models trained on enormous data sets to rapidly and accurately recognize features associated with a narrowly-defined set of inputs and outputs. Examples of models and computing platforms which excel at implementing and training models on large, well formatted bodies of data to rapidly and accurately perform narrowly-defined pattern recognition operations, include image recognition models, which are initially trained on very large datasets (for example, the Open Images Dataset or ImageNet) and can be further trained using image data scraped from the web or other sources to recognize specific features in images (for example, faces or tagged objects).

While performing pattern recognition for a narrowly defined set of inputs and outputs, particularly inputs and outputs for which there are large, well-curated or “canned” datasets (such as image data) can be done rapidly and accurately on a wide variety of computing platforms (including smartphones), implementing AI/ML pattern recognition at scale on large datasets which are heterogeneous (i.e., of multiple formats and from multiple sources) and dynamic (constantly growing and changing) requires processing power beyond that provided by many platforms. Further, implementing AI/ML pattern recognition at scale and at speeds to make time-sensitive predictions associated with control inputs for a plurality of nodes of a system (for example, a set of inputs specifying the quantity of ingredients each store of a restaurant chain should order to meet the predicted demand for the next 48 hours, or an input allocating resources within nodes of an energy distribution network to meet predicted demand for the next 24 hours) presents further computational challenges which are highly dependent on the performance and efficiency of the architecture of the processing platform implementing the model and providing control outputs.

The above-described computational challenges may be further increased as the inputs and outputs to the system become more broadly defined. As used in this disclosure, broad definition of inputs encompasses a relative increase in the types and variables presented to the model. Further, as used in this disclosure, broad definition of outputs encompasses a relative increase in the concepts or patterns within the data an AI/ML model is tasked to recognize.

Thus, refining computer architectures for implementing AI/ML predictive models using heterogeneous data and with potentially broadly defined inputs and outputs, at scales and speeds suitable for providing effective control inputs to a multi-node network remains a source of technical challenges and opportunities for improvement in the art.

Further, refining AI/ML models to meet the specific predictive needs of networks of entities within the certain industries (for example, chain food restaurants), where the available inputs and desired outputs can be both highly general (for example, where most of the restaurants share a common menu) and highly local, or specific (for example, where local conditions, such as weather or demographics highly influence sales performance also remains a source of technical challenges and opportunities for improvement in the art.

### SUMMARY

This disclosure provides systems and methods for large-scale accelerated parallel predictive modeling and control.

In a first embodiment, a method for parallel predictive modelling includes receiving a configuration file associated with a predictive concept at a production layer of a predictive modelling platform, the predictive modelling platform comprising the production layer and a consumption layer, wherein the production layer and the consumption layer are communicatively connected by a distributed messaging system. The method further includes identifying, by the production layer, a job request based on the configuration file, sending, by the distributed messaging system, the job request to the consumption layer, as one of a plurality of job requests to be passed to a predictive model implemented by a processing container, wherein the predictive model is specified by the configuration file, obtaining, from the processing container, a forecast as an output of the predictive model, sending, by the distributed messaging system, the forecast to the production layer and determining, by the production layer, one or more values of the predictive concept based on the forecast and an operator specified by the configuration file.

In a second embodiment, a platform includes a processor and a non-transitory memory or other non-transitory computer-readable medium. The non-transitory memory contains instructions, which, when executed by the processor, cause the platform to receive a configuration file associated with a predictive concept at a production layer of the platform, wherein the platform comprises the production layer and a consumption layer, wherein the production layer and the consumption layer are communicatively connected by a distributed messaging system, identify, by the production layer, a job request based on the configuration file, send, by the distributed messaging system, the job request to the consumption layer, as one of a plurality of job requests to be passed to a predictive model implemented by a processing container, wherein the predictive model is specified by the configuration file, obtain, from the processing container, a forecast as an output of the predictive model, send, by the distributed messaging system, the forecast to the production layer, and determine, by the production layer, one or more values of the predictive concept based on the forecast and an operator specified by the configuration file.

In a third embodiment, a non-transitory, computer-readable medium includes instructions, which when executed by a processor, cause a predictive modelling platform to receive a configuration file associated with a predictive concept at a production layer of the platform, wherein the platform comprises the production layer and a consumption layer, wherein the production layer and the consumption layer are communicatively connected by a distributed messaging system, identify, by the production layer, a job request based on the configuration file, send, by the distributed messaging system, the job request to the consumption layer, as one of a plurality of job requests to be passed to a predictive model implemented by a processing container, wherein the predictive model is specified by the configuration file, obtain, from the processing container, a forecast as an output of the predictive model, send, by the distributed messaging system, the forecast to the production layer, and determine, by the production layer, one or more values of the predictive concept based on the forecast and an operator specified by the configuration file.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a non-limiting example of a device for providing data to a predictive modelling platform and/or receiving control inputs from a predictive modelling platform according to some embodiments of this disclosure;

FIG. 2 illustrates an example of a server that can be configured to act as a computing platform or part of a computing platform for large-scale accelerated parallel predictive modeling and control, according to certain embodiments of this disclosure;

FIG. 3 illustrates aspects of an example network of nodes which variously provide data to a predictive modelling platform and/or receive control inputs from a predictive modelling platform, according to various embodiments of this disclosure;

FIG. 4 illustrates, in block diagram format, an example of an architecture of a predictive modelling platform according to various embodiments of this disclosure;

FIG. 5 illustrates operations of an example method for training a deep learning predictive model and for obtaining a value of a predictive concept, according to certain embodiments of this disclosure;

FIG. 6 illustrates operations of an example method for performing parallel predictive modelling according to various embodiments of this disclosure;

FIG. 7 illustrates an example of modules of a production layer according to various embodiments of this disclosure; and

FIG. 8 illustrates an example of placing a supply order through a predictive modeling platform according to various embodiments of this disclosure.

### DETAILED DESCRIPTION

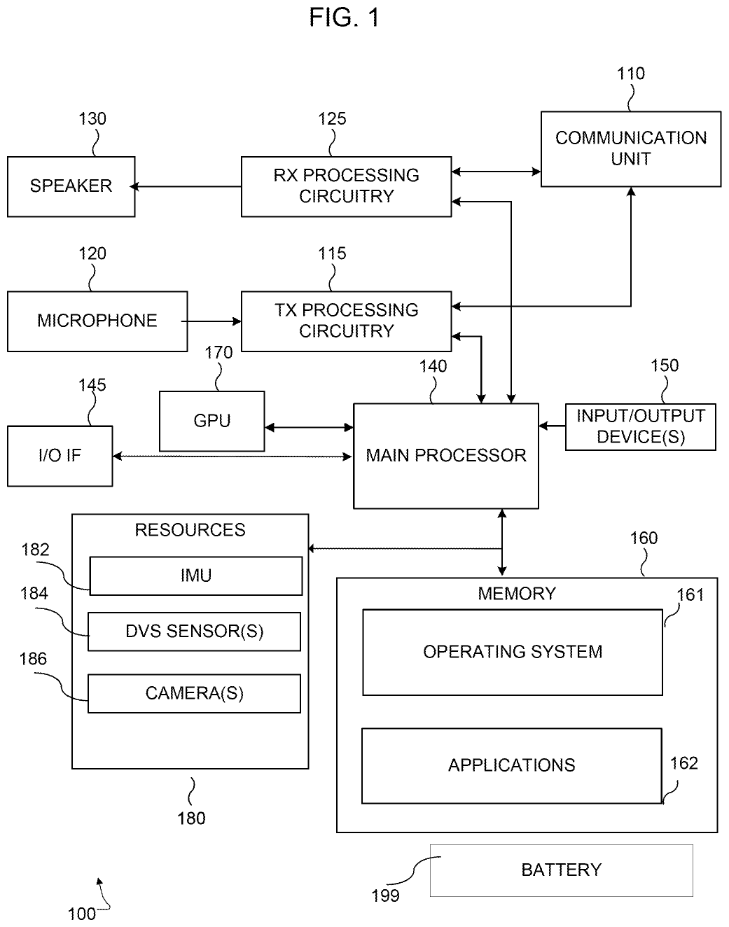

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged processing platform.

FIG. 1 illustrates a non-limiting example of a device or system 100 for providing data to a predictive modelling platform and/or receiving control inputs from the predictive modelling platform according to some embodiments of this disclosure. According to various embodiments of this disclosure, device 100 could be implemented as one or more of a smartphone, a tablet, a laptop computer, a cash register, point of sale terminal or other computing system. The embodiment of device 100 illustrated in FIG. 1 is for illustration only, and other configurations are possible. However, suitable devices come in a wide variety of configurations, and FIG. 1 does not limit the scope of this disclosure to any particular implementation of a device.

As shown in the non-limiting example of FIG. 1, the device 100 includes a communication unit 110 that may include, for example, a radio frequency (RF) transceiver, a BLUETOOTH transceiver, or a WI-FI transceiver, etc., transmit (TX) processing circuitry 115, a microphone 120, and receive (RX) processing circuitry 125. The device 100 also includes a speaker 130, a main processor 140, an input/output (I/O) interface (IF) 145, input/output device(s) 150, and a memory 160. The memory 160 includes an operating system (OS) program 161 and one or more applications 162, and further configured to store data.

Applications 162 can include web browsers, games, social media applications, applications for geotagging photographs and other items of digital content, virtual reality (VR) applications, augmented reality (AR) applications, operating systems, device security (e.g., anti-theft and device tracking) applications or any other applications which generate data associated with the operation of a node of a network which provides data to and/or receives control inputs from the predictive modelling platform. Examples of nodes of such a network include, without limitation, a restaurant within a chain of restaurants, a turbine or windmill of a wind farm, a set of panels of a solar farm, or a computer within a cloud computing center (i.e., a server farm). Further examples of nodes which generate data, and whose operation can be tuned (for example, by increasing their productivity, uptime or efficiency through control inputs generated based on a predictive model) are possible and within the scope of this disclosure. According to some embodiments, the resources of device 100 include, without limitation, speaker 130, microphone 120, input/output devices 150, and additional resources 180.

The communication unit 110 (having one or more antennas) may receive an incoming RF signal, for example, a near field communication signal such as a BLUETOOTH or WI-FI signal, or other wireless communications signals. The communication unit 110 can down-convert the incoming RF signal to generate an intermediate frequency (IF) or baseband signal. The IF or baseband signal is sent to the RX processing circuitry 125, which generates a processed baseband signal by filtering, decoding, or digitizing the baseband or IF signal. The RX processing circuitry 125 transmits the processed baseband signal to the speaker 130 (such as for voice data) or to the main processor 140 for further processing (such as for web browsing data, online gameplay data, notification data, or other message data). Additionally, communication unit 110 may contain a network interface, such as a network card, or a network interface implemented through software, configured to transmit and/or receive data communications via wireline to remote or external devices.

The TX processing circuitry 115 receives analog or digital voice data from the microphone 120 or other outgoing baseband data (such as web data, e-mail, or interactive video game data) from the main processor 140. The TX processing circuitry 115 encodes, multiplexes, or digitizes the outgoing baseband data to generate a processed baseband or IF signal. The communication unit 110 receives the outgoing processed baseband or IF signal from the TX processing circuitry 115 and up-converts the baseband or IF signal to an RF signal for transmission.

The main processor 140 can include one or more processors or other processing devices and execute the OS program 161 stored in the memory 160 in order to control the overall operation of the device 100. For example, the main processor 140 could control the reception of forward channel signals and the transmission of reverse channel signals by the communication unit 110, the RX processing circuitry 125, and the TX processing circuitry 115 in accordance with well-known principles. In some embodiments, the main processor 140 includes at least one microprocessor or microcontroller. According to certain embodiments, main processor 140 is a low-power processor, such as a processor which includes control logic for minimizing consumption of battery 199 or minimizing heat buildup in device 100.

The main processor 140 is also capable of executing other processes and programs resident in the memory 160. The main processor 140 can move data into or out of the memory 160 as required by an executing process. In some embodiments, the main processor 140 is configured to execute the applications 162 based on the OS program 161 or in response to inputs from a user or applications 162. Applications 162 can include applications specifically developed for the platform of device 100, or legacy applications developed for earlier platforms. The main processor 140 is also coupled to the I/O interface 145, which provides the device 100 with the ability to connect to other devices such as laptop computers and handheld computers. The I/O interface 145 is the communication path between these accessories and the main processor 140.

The main processor 140 is also coupled to the input/output device(s) 150. The operator of the device 100 can use the input/output device(s) 150 to enter data into the device 100. Input/output device(s) 150 can include keyboards, touch screens, mouse(s), track balls or other devices capable of acting as a user interface to allow a user to interact with device 100. In some embodiments, input/output device(s) 150 can include a touch panel, an augmented or virtual reality headset, a (digital) pen sensor, a key, or an ultrasonic input device.

Input/output device(s) 150 can include one or more screens, which can be a liquid crystal display, light-emitting diode (LED) display, an optical LED (OLED), an active-matrix OLED (AMOLED), or other screens capable of rendering graphics.

The memory 160 is coupled to the main processor 140. According to certain embodiments, part of the memory 160 includes a random-access memory (RAM), and another part of the memory 160 includes a Flash memory or other read-only memory (ROM). Although FIG. 1 illustrates one example of a device 100, various changes or modifications can be made to FIG. 1 as will be understood by those skilled in the art.

For example, according to certain embodiments, device 100 can further include a separate graphics processing unit (GPU) 170.

According to certain embodiments, device 100 includes a variety of additional resources 180 which can, if permitted, be accessed by applications 162. According to certain embodiments, additional resources 180 may include sensors for detecting or sensing physical or environmental phenomenon, such as an accelerometer or inertial measurement unit (IMU) 182, which can detect movements of the electronic device along one or more degrees of freedom. Additional resources 180 include, in some embodiments, one or more dynamic vision sensors 184, and one or more cameras 186 (for example, complementary metal oxide semiconductor (CMOS) sensor type cameras) of device 100. According to various embodiments, DVS sensor(s) 184 comprises a pair of dynamic vision sensors spaced at a stereoscopically appropriate distance for estimating depth at over a field of depth of interest. According to some embodiments DVS sensor(s) 184 comprise a plurality of DVS sensors with overlapping, or partially overlapping fields of view. While not shown in the figure, further examples of additional resources 180 can include, without limitation, global positioning sensors (GPS), or other apparatus providing location and speed data, from which transit and arrival times associated with control inputs can be determined.

According to various embodiments, the device 100 may be powered by any typical or conventional power source (e.g., conventional A/C power, battery power, etc.), and in one embodiment, operating power is provided by a battery 199 (for example, a rechargeable lithium-ion battery), whose size, charge capacity and load capacity are, in some embodiments, constrained by the form factor and user demands of the device. As a non-limiting example, in embodiments where device 100 is a smartphone or portable device (for example, a portable terminal used by restaurant waitstaff), battery 199 is configured to fit within the housing of the smartphone.

Although FIG. 1 illustrates one example of a device 100 for providing data to a predictive modelling platform or receiving control inputs from the predictive modelling platform, various changes may be made to FIG. 1. For example, the device 100 could include any number of components in any suitable arrangement. As one illustrative example, device 100 could be embedded as a controller for an electromechanical system, such as a wind turbine or a pumpjack for an oil well, comprising one element of a larger element of electromechanical systems. As another illustrative example, the device 100 may be a computer or processing system (e.g., POS system) within a restaurant. In general, devices including computing and systems control platforms come in a wide variety of configurations, and FIG. 1 does not limit the scope of this disclosure to any particular configuration. While FIG. 1 illustrates one operating environment in which various features disclosed in this patent document can be used, these features could be used in any other suitable system.

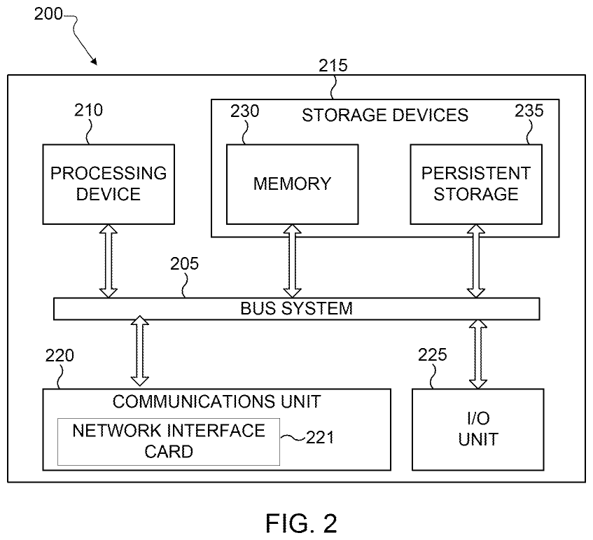

FIG. 2 illustrates an example of a server or computer system 200 that can be configured to act as a computing platform or part of a computing platform for large-scale accelerated parallel predictive modeling and control according to certain embodiments of this disclosure. The embodiment of the server 200 shown in FIG. 2 is for illustration only and other embodiments could be used without departing from the scope of the present disclosure. According to certain embodiments, the server 200 operates as a gateway for data passing between a device of a secure internal network (for example, device 100 in FIG. 1), and an external network, such as the internet.

In the example shown in FIG. 2, the server 200 includes a bus system 205, which supports communication between at least one processing device 210, at least one storage device 215, at least one communications unit 220, and at least one input/output (I/O) unit 225.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, application specific integrated circuits, and discrete circuitry. In certain embodiments, the server 200 can be part of a cloud computing network, and processing device 210 can be an instance of a virtual machine or processing container (for example, a Microsoft Azure Container Instance, or a Google Kubernetes container). Given the scale of the processing operations performed by certain embodiments according to this disclosure, the processing and storage elements of the server 200 may be implemented through cloud computing systems.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random-access memory or any other suitable volatile or non-volatile storage device(s). The persistent storage 235 may contain one or more components or devices supporting longer-term storage of data, such as a ready only memory, hard drive, Flash memory, or optical disc. According to various embodiments, persistent storage 235 is provided through one or more cloud storage systems (for example, Amazon S3 storage).

The communications unit 220 supports communications with other systems or devices. For example, the communications unit 220 could include a network interface card 221 or a wireless transceiver facilitating communications over the network 102. The communications unit 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

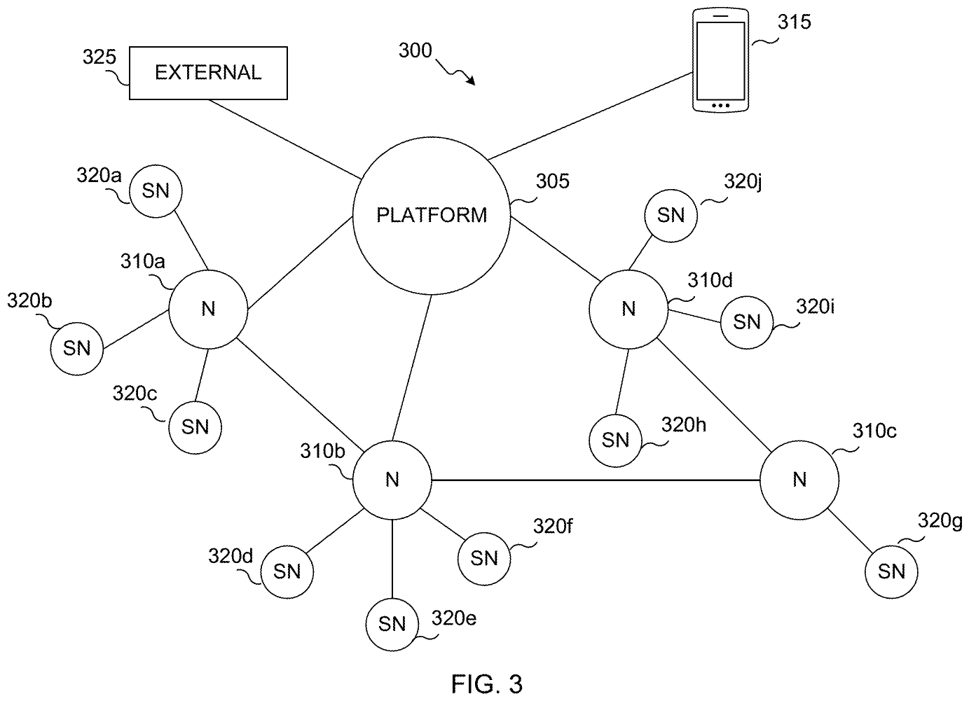

FIG. 3 illustrates aspects of an example network 300 of nodes or devices/systems which variously provide data to a predictive modelling platform 305 and/or receive control inputs and/or data from the predictive modelling platform 305.

Referring to the illustrative example of FIG. 3, the network 300 comprises a plurality of nodes or devices (for example, nodes 310a-d, 320i-j, 315 and 325) which are communicatively connected, either directly or indirectly, via one or more networks to predictive modelling platform 305. According to various embodiments, predictive modelling platform 305 includes one or more servers (for example, server 200) or cloud computing platforms configured to implement one or more deep learning AI/ML models trained to generate inferences (for example, discovery of patterns in the data showing latent relationships between features of the data) as well as generate predictions providing the basis of control inputs for one or more of the nodes/devices of the network. Deep learning models present a variety of performance benefits over machine learning models (for example, artificial neural networks) with either fewer layers or without back propagation. The benefits of deep learning models include, without limitation, the ability to detect latent patterns or patterns dependent on latent (or unobserved variables), and the ability to extract features from the data, as an alternative to manually defining features, which can be time-consuming and inaccurate. In many cases, the performance benefits of deep learning AI/ML models are realized by the models being data hungry (i.e., they require a lot of data to train) and computationally expensive (i.e., training, updating and implementing the model requires large amounts of processing resources). As will be described in this disclosure, for most embodiments, numerous nodes of network 300 provide sufficient data for training the one or more models implemented at platform 305, and the primary technical challenge confronting platform 305 is how to timely and efficiently process data from across network 300 to obtain predictions from which timely control inputs can be provided to some or all (or relevant ones) of the nodes of network 300. Put more simply, platform 305 needs to generate control inputs based on predicted future conditions across network (for example, demand at a restaurant, or an anticipated load at a section of a power grid) in time for action to be taken.

Referring to the illustrative example of FIG. 3, the nodes of network 300 can be hierarchical and comprise primary nodes (for example, primary nodes 310a through 310d) and secondary nodes (for example, secondary nodes 320a through 320j). According to some embodiments, a primary node may be a cell of an entity of a group of analytically analogous entities, which receive control inputs from platform 305. Examples of primary nodes include, without limitation, a restaurant in a chain of restaurants with a common menu and supply chain, a rack of machines in a server farm, or a turbine/windmill in a wind farm, whose operation can be tuned, or optimized through predictive control inputs.

As one example where primary node 310a is a restaurant within a larger chain of restaurants within network 300, the efficiency of primary node, as measured in terms of labor and material inputs, may be improved by reducing the staffing and stock of perishable inputs (for example, fresh produce) on days or times where demand is expected to be low. As another example, where primary node 310a is a remotely controlled pumpjack in an oil field, the performance of the pump jack, as measured by overall profitability, may be improved by shutting off the pump jack on days where the predicted price of electricity to power the pump is high relative to the predicted price of extracted oil. Depending on embodiments, primary nodes 310a-d may be embodied either as servers (for example, server 200 in FIG. 2) or standalone devices or computing systems (for example, device 100 in FIG. 1) which interface with platform 305 through one or more application programming interfaces (APIs). In certain real-world implementations of processing platforms according to this disclosure, there may be hundreds, thousands and perhaps more primary nodes within a network.

Referring to the illustrative example of FIG. 3, network 300 comprises a plurality of sub-nodes 320a-j. According to various embodiments, a sub-node (for example, sub-320a) comprises a networked processing platform which collects data associated with a parent node (for example, primary node 310a) or whose operation is guided, at least in part, by control inputs or other data generated from predictive modelling performed at platform 305. In some embodiments, a sub-node may be a sub-system of the system comprising the primary node. As one illustrative example, a server rack may be a primary node, and each constituent server of the rack may be a secondary node. As a further example, in some embodiments where the primary nodes comprise restaurants within a chain, secondary nodes may comprise point of sale terminals (for example, registers) or back-of-the-house order management systems. While not shown in FIG. 3, the hierarchical relationship at a primary node may have further layers beyond the primary node and sub-nodes shown in FIG. 3, with additional devices occupying further subordinate roles (for example, sub-sub-nodes). In other embodiments and using a chain of restaurants as an example system, the secondary nodes may be omitted (as merely a tool for collecting data about a restaurant) and each primary node corresponds to a restaurant.

According to various embodiments, network 300 further comprises one or more entities which consume control inputs or other outputs (for example, predictions, analyses and simulation results) from platform 305, but which do not provide any data for feeding the one or more deep learning models implemented at platform 305. Examples of such nodes include, without limitation, an external terminal or device 315, which may be a networked computing platform hosting a user interface through which operations of platform 305 can be configured, and from which reports and data can be pulled from platform 305. Further examples of “receive only” nodes include APIs or other interfaces to one or more external systems or devices 325. For example, in embodiments in which platform 305 performs predictive modelling for a chain of restaurants, external systems 325 may include APIs for vendors or suppliers (for example, a food/goods supplier) of a core ingredient used at restaurants comprising primary nodes 310a-310d.

As will be appreciated, the primary nodes 310, the secondary nodes 320, the external terminal device 315 and the external systems or devices 325 may be implemented by a device or server, such as the device 110 or a device that may include all or some of the structures and functionality as described with respect to the device 100.

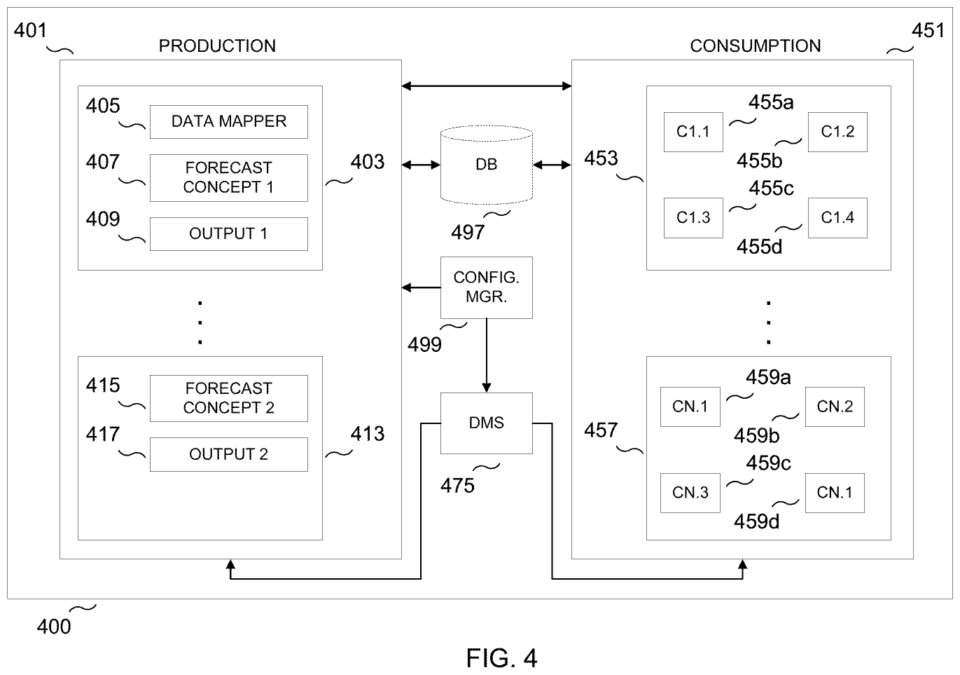

FIG. 4 illustrates, in block diagram format, an example of an architecture of a predictive modelling platform 400 (for example, the platform 305 in FIG. 3) according to various embodiments of this disclosure.

Predictive modelling platform 400 embodies a computational architecture which provides the practical benefit of performing at a high level across multiple, competing dimensions of system performance, and is well-suited for implementing deep learning model-based analyses and generating control outputs for a large number of controlled nodes under real-world constraints. In contrast to research, academic or other non-real-world implementations of deep learning models, where the performance of the system implementing the model is measured along a single dimension—most typically, how performant the model is (for example, how accurately does it recognize faces, or whether it has been trained to overcome common error cases), the performance of practical, real-world implementations of deep learning models is measured along multiple, competing dimensions of performance. For example, real-world implementations need to be performant (i.e., recognizing relevant patterns with a useful degree of accuracy) and implemented quickly (i.e., predictions must be generated quickly enough to be timely, and not post hoc estimates of conditions that have already occurred), but at the same time, implementations must, to the extent possible, be computationally efficient. Further, in contrast to academic implementations, architectures supporting real-world implementations generally need to be configured to handle messy, heterogenous training data maintained across a variety of formats and locations and be expected to provide a broadly defined set of outputs (as opposed to, for example, recognizing faces or objects in image data) in which outputs associated with multiple predictive concepts may be provided by the platform. Additionally, depending on embodiments, the constraints on real-world implementations of deep learning modelling platforms is that the platform be extensible in its ability to provide outputs with additional predictive concepts and handle receiving data and providing control outputs to an increased number of nodes.

Referring to the illustrative example of FIG. 4, platform 400 (for example, the platform 305 in FIG. 3) is, for many enterprise-scale implementations, embodied across a variety of networked machines, including, without limitation, in-house servers and one or more cloud-based storage or processing platforms. However, purely in-house (i.e., on an enterprise's own computers) or purely cloud-based implementations of platform 400 are possible and within the contemplated scope of this disclosure. Although the description herein of the platform 400 and functionality will be directed to an implementation or application within a chain of restaurants, the platform 400 and functionality may be utilized in different applications.

While platform 400 embodies an extensible architecture, which can readily include components beyond those shown in the figure, the building blocks of platform 400 comprise production layer 401, a consumption layer 451, a distributed messaging system (DMS) 475, and a configuration manager 499. Depending on embodiments, the components of platform 400 may further include one or more databases (DB) 497.

According to various embodiments, platform 400 implements a configuration driven architecture, wherein the operations (for example, which predictive model is used, which modules of the production layer are used, and timing of processing) performed by platform 400 are defined according to a plurality of configuration files, wherein each configuration file is associated with one or more predictive concepts.

In this disclosure, the term “predictive concept” encompasses a pairing of a machine learning modelling operation performed by the consumption layer 451 with an output provided by production layer 401. As an accessible, non-limiting example, in the case where the platform is connected to a network of nodes (for example, network 300 in FIG. 3) and the nodes are restaurants of a chain of restaurants, predictive concepts might include, a forecast of the number of labor man-hours required to handle a time window for a given day, or programmatically issued control commands (for example, an order for ingredients and ancillary supplies, such as napkins, straws and cooking oil) to a supplier (e.g., external system 325) based on the predicted sales of a core item (for example, pieces of chicken at a fried chicken restaurant). Skilled artisans will appreciate that, as the network of nodes connected to, and receiving control commands, grows, the number of predictive concepts handled by platform 400 likewise scales. In certain real-world implementations, the performance demands on platform 400 can include updating one or more deep learning models and implementing multiple predictive concepts from a network comprising thousands of nodes. Staying with the accessible, non-limiting example of a platform 400 tasked with processing predictive concepts for a chain of restaurants, when the data from each node includes multiple items of data for each transaction, the net volume of data processed at platform 400 becomes enormous.

Referring to the illustrative example of FIG. 4, production layer 401 includes an extensible set of modules 403 through 413, wherein each module is configured to provide one or more outputs associated with predictive concepts. While it is possible to train and retrain deep learning models to recognize patterns for each predictive concept of interest, this approach can present significant inefficiencies, dramatically increased computational expense, and limit extensibility and flexibility, making it unsuitable for real-world implementations of deep learning based predictive modelling.

Returning to the example of a large network connected to platform 400, wherein the nodes are restaurants of a chain selling a core menu item (for example, fried chicken), the efficiency of each node can be improved through a number of predictive concepts, such as a forecast of the amount of ingredients needed to be purchased for a given day, a forecast of the expected labor for a given day, and a forecast of related supplies to be purchased for a given period. Accurate forecasting of these essential operating parameters of a node can reduce waste and improve the efficiency of the restaurant.

While it is possible for each predictive concept to have its own deep learning model, this approach can be undesirably inefficient and inflexible. In the example of a network wherein the nodes are restaurants selling fried chicken, many, if not all, of the predictive concepts having an effect on the efficiency of the nodes, are proportional to, or, at a minimum, conceptually linked to, the number of units of fried chicken sold. Given this, it is inefficient and redundant to implement separate computationally expensive deep learning models for predicting labor, ingredients and supply requirements, as these three inputs are fundamentally related. Further, the relationship between the predicted value of predictive concept (for example, the number of units of chicken forecast to be sold on “Day X”) and a control command associated with the predictive concept may reflect user-tunable variables which are not easily captured by the model. Continuing with the example of a network in which the nodes are fried chicken restaurants, platform 400 may generate a control command including an ingredient order message presented to the API of a supplier (e.g., external system 325) to the restaurant chain. In this example, the quantity of, for example, chicken specified in the order message may be the predicted value for the day, and in another embodiment may be a value as a function of the predicted value and other parameters, including user-defined parameters, such as the size of a reserve, or buffer quantity of the ingredient to be maintained (in some cases, running out of product to sell may be worse than wasting product). In many cases, it is easier to reconfigure the last-mile processing of a predictive output to account for further variables, than to retrain a deep learning model to account for the further variables.

To promote the efficiency, extensibility and flexibility typically demanded of practical, real-world implementations of deep learning predictive modelling platforms, the architecture of platform 400 splits the processing associated with generating values of predictive concepts and control commands based on the generated values of predictive concepts across a production layer 401 and a consumption layer 451. In certain embodiments, production layer 401 receives configuration files associated with predictive concepts, generates job requests for predictive modelling, which are passed to consumption layer 451. The outputs of the job requests are returned from consumption layer 451 to production layer 401, for further algorithmic or rule-based processing to one or more values of the predictive concept specified by the originally received configuration file. In this way, production layer 401 provides the “first mile” and “last mile” processing of generating values of predictive concepts, while consumption layer 451 can implement multiple instances of a deep learning model from which values of multiple predictive concepts can be obtained. In this way, the overall efficiency of platform 400 can be improved by running parallel instances of the same deep learning model at consumption layer 451, and then performing further processing or algorithmic adjustment (for example, to generate a prediction of a volume of cooking oil required based on sales forecasts for chicken) to obtain a value of a predictive concept from a forecast output by consumption layer 451.

As shown in the illustrative example of FIG. 4, production layer 401 includes a plurality of modules, including modules 403 and 413. In this example, a first module 403 and a second module 413 are shown in the figure, though embodiments with greater or fewer modules are possible and within the contemplated scope of this disclosure. In the example of FIG. 4, each of modules 403 and 413 comprise instances of the components for creating a predictive modelling job request to be provided to consumption layer 451, and for the further algorithmic or rules-based processing associated with generating an output based on a forecast returned from consumption layer 451. According to various embodiments, the components of first module 403 can comprise applications, algorithms (for example, clustering algorithms) or instances of classes (for example, classes containing “post” or “get” methods).

In the non-limiting example of FIG. 4, first module 403 includes a module for placing a supply order for nodes of a network connected to platform 400. In this example, first module 403 obtains from one or more deep learning models implemented at consumption layer 451, a predicted value of a parameter of interest to a predictive concept, and generates, as an output a control command to a node within a network of nodes providing data or receiving control inputs from platform 400. According to certain embodiments, first module 403 includes the following components—a data mapper 405, a module 407 for obtaining a value of a predictive concept from a forecast output by an instance of predictive model in consumption layer 451, and a module 409 for generating a control output to a node of a network (for example, network 300 in FIG. 3) connected to platform 400.

As noted elsewhere in this disclosure, in many, current real-world implementations of predictive modelling across large networks of data providing and input-consuming nodes, data relevant to training the predictive model or obtaining outputs can be messy—in the sense that the data resides across a plurality of storage platforms (for example, a combination of in-house servers and cloud computing platforms) with proprietary interfaces. Data mapper 405 specifies or identifies the locations of data required for first module 403 to generate a specified control output, as well as the commands or methods for specifically obtaining the data. In some embodiments, data mapper 405 comprises a table of containers identifying locations where particular types of data are maintained, and a library of APIs and platform specific versions of common methods for obtaining or writing data of interest (for example, “POST” and “GET” calls).

According to some embodiments, module 407 contains control logic, for example, an algorithm or defined sequence of operations for manipulating a forecasted value from consumption layer 451 into a value of a specific predictive concept. Returning to the example in which platform 400 operates as a predictive brain center for a network of restaurants built around a core menu offering (in this example, fried chicken), module 407 may, in some embodiments, implement the processing logic for ordering frying oil. While a particular restaurant's oil requirements are related to their chicken sales, the relationship between chicken cooked and oil required depends on a number of variables, some of which have values informed by past data (i.e., when was the oil last changed, and how many items were cooked in it), as well as other parameters (for example, does corporate policy or a health code specify conditions under which cooking oil must be changed). The module 407 draws upon data provided by data mapper 405 to obtain the historical data and other parameters needed to algorithmically translate a forecast (for example, expected fried chicken sales for restaurant “X” on day “Y”) generated by a deep learning model in consumption layer 451 into value of a predictive concept (for example, a projection of restaurant “X's” cooking oil requirements that is based on predicted chicken sales, past oil usage and other relevant parameters).

According to various embodiments, module 409 translates the value of the predictive concept generated at module 407 into a control command (for example, an API of an external system) which is sent out to a computing platform external to platform 400 (for example, external platform 325 in FIG. 3). Returning to the explanatory hypothetical in which first module 403 prepares a job request for a deep learning model-based prediction of a parameter (for example, a number of pieces of chicken forecast to be sold on a given day at a given store) associated with a predictive concept (for example, the given store's predicted cooking oil requirements), the control command output by module 409 includes an electronic order for a given quantity of cooking oil. While the operations of first module 403 have been described with reference to leveraging the two-layer architecture of platform 400 for generating control commands for individual nodes of a network of restaurants (for example, nodes 310a-310d in FIG. 3) and external entities, such as restaurant suppliers, embodiments according to this disclosure are not so limited, and the improvements in efficiency, extensibility and flexibility provided by platform 400 can find practical application in other systems utilizing deep learning predictive control over parameters affecting a large number of nodes—such as wind farms, distributed computing networks, and power grids.

Referring to the illustrative example of FIG. 4, the modules within the production layer 401 themselves employ a modular architecture and can comprise greater or fewer modules than first module 403. As an explanatory example, while first module 403 provides an example of a module for generating a control command as an output, second module 413 provides an example of a dashboard, or reporting module. According to certain embodiments, second module 413 includes a module 415 for defining the parameters of one or more job requests to be passed to predictive model(s) running in consumption layer 451, and for performing further processing to account for historical data, user-tuned parameters, and other factors defining the relationship between the value(s) of a forecast output by a predictive model and the value of a predictive concept. Second module 413 further includes a module 417, which outputs the value of the predictive concept. For example, in embodiments where second module 413 is a reporting application, module 417 may output the value of the predictive concept according to a format specified by a reporting application (for example, as a graphical item). As one illustrative, restaurant-based example, the value of the predictive concept may be units of fried chicken (which corresponds to how product is ordered at a restaurant), but output module 417 reports the value of the predictive concept as a weight value (which corresponds to how the product is ordered and priced by the restaurant's suppliers).

According to certain embodiments, platform 400 further comprises a distributed messaging system (DMS) 475. In this example, DMS 475 operates as a middleware layer and primary intermediary between configuration manager 499, production layer 401 and consumption layer 451, which, in many embodiments, are implemented on separate (and often-cloud based computing platforms). By routing at least part of the traffic (for example, job requests to be passed to predictive models at consumption layer 451) through DMS 475, the technical and administrative challenges of configuring a variety of potentially independently developed components to interact cohesively is vastly reduced. According to certain embodiments, DMS 475 includes an implementation of Apache Pulsar, Stampy or other distributed messaging system.

As shown in the explanatory example of FIG. 4, platform 400 further includes a configuration manager 499. According to various embodiments, configuration manager 499 stores and pushes out configuration messages which initiate and define the parameters of generating an output (for example, a control command) associated with a specified predictive concept. As such, in some embodiments, configuration manager comprises a storage component (i.e., either storing the configuration files, or alternatively, maintaining a storage index or other identification of the configuration files and their storage locations) and queuing or scheduling functionality, which determines which configuration files to push out to initiate operations at production layer 401 and consumption layer 451.

According to various embodiments, platform 400 further includes one or more databases (DB) 497, which maintain data collected across the nodes of the network (for example, network 300 in FIG. 3) for which platform 400 provides analytical and control support functionalities. Given the scale and heterogeneity of the data collected and passed to the one or more deep learning models implemented at consumption layer 451, database 497 may include a plurality of databases implemented on one or more heterogeneous data storage devices or platforms (for example, Snowflake databases, Amazon S3 databases, and databases maintained on in-house servers), whose collective contents are accessed and managed in part through one or more instances of data mapper 405.

The platform 400 further includes a consumption layer 451 having one or more processing containers (for example, a first container 453 and a second container 457), wherein each processing container implements one or more instances of deep learning model(s) trained on data collected across the network of nodes (for example, network 300 in FIG. 3) supported by platform 400.

In many real-world, practical applications, training and passing inputs through deep learning models requires significant amounts of data, and processing across multiple hidden layers of the model. The volume of data and depth of the model typically combine to make implementation of predictions at the model computationally very expensive. To tailor the computational power to actual processing demand and avoid the inefficiencies associated with unused processing power, the deep learning models for forecasting parameters linked to predictive concepts may be implemented in instances of containers (for example, Google Kubernetes containers) on a cloud computing platform. In this way, platform 400 has scalable processing power, which can be tuned to the volume of job requests and outputs provided by consumption layer 451. Within each container (for example, first container 453) a plurality of job requests (for example, job requests 455a-d) based on the same predictive model can be processed at the same time.

Further, where the range of predictive concepts used by modules of production layer 401 is more than what a single deep learning model can support, different models can be run in separate containers. In the illustrative example of FIG. 4, second container 457 comprises four instances (459a-d) of job requests using a second predictive model.

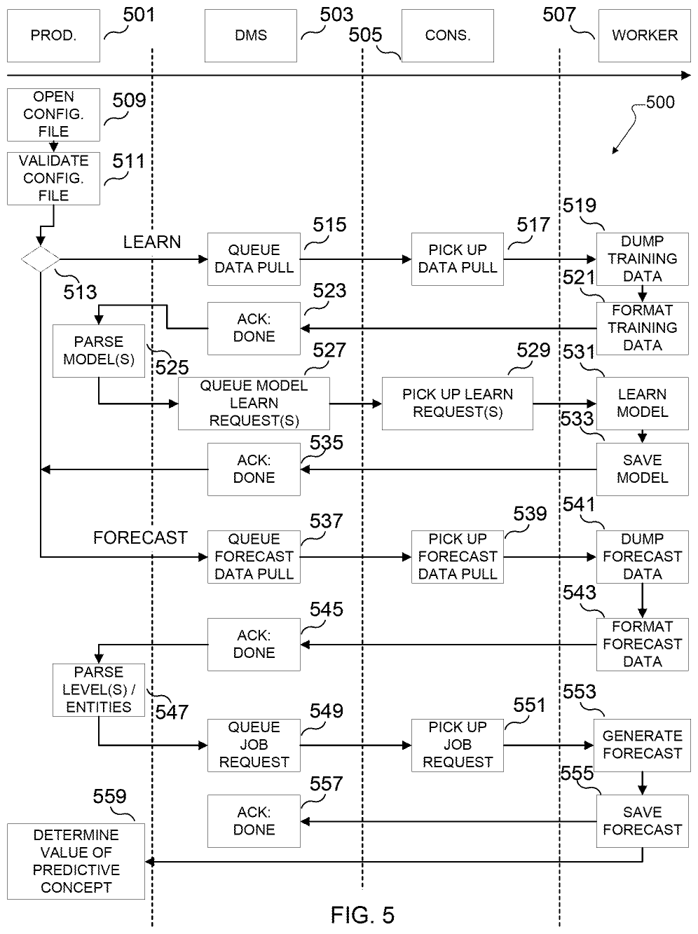

FIG. 5 illustrates operations of an example method 500 for training deep learning predictive model and for obtaining a value of a predictive concept, according to certain embodiments of this disclosure. The operations described with reference to FIG. 5 can be performed on a variety of computing platforms, including computing platforms embodying the architecture of platform 400 in FIG. 4 of this disclosure.

Referring to the non-limiting example of FIG. 5, method 500 can be implemented on a computing platform including a production layer 501 (for example, an instance of production layer 401 in FIG. 4), a distributed messaging system 503 (for example, an instance of DMS 475 in FIG. 4), a consumption layer 505 (for example, consumption layer 451 in FIG. 4) and one or more workers 507 within a processing container. As used in this disclosure, the expression “worker” encompasses a unitary fraction of the processing capability of a single processing container or virtual machine. As an example, in some embodiments, the containers (for example, first container 453 in FIG. 4) may be implemented as individual Microsoft Azure containers, wherein a single Azure container can perform five training and forecasting operations in parallel at once. In this example, the container is said to have a five “workers.”

As shown in FIG. 5, at block 509, production layer receives (for example from configuration manager 499 in FIG. 4) a configuration file associated with a predictive concept. For purposes of describing the method 500 herein, the use of the term “block” refers to a step in the method or action(s) taken. Certain embodiments according to this disclosure implement a configuration driven architecture, wherein the configuration file received and opened at block 509 operates as a combination order ticket and recipe for the processing and predictive operations to be performed at production layer 501. According to certain embodiments, the configuration file specifies which module of production layer 401 converts a forecast from consumption layer 451 to a value of a predictive concept, the data to be pulled (for example, by data mapper 405 from database 497 in FIG. 5), which predictive model is to be implemented at consumption layer 451. Returning to examples made familiar by this disclosure, in the illustrative example of FIG. 5, the predictive concept specified by the configuration could be the predicted cooking oil needs for a given restaurant in a chain of restaurants in an upcoming supply order cycle.

At block 511, production layer 501 validates the configuration file. According to various embodiments, the computing platform implementing method 500 is embodied on a distributed and flexibly configured architecture. In certain embodiments, validation of the configuration file at block 511 includes confirming that the configuration file specifies current components of the platform. In some embodiments, validation of a configuration file may include confirming that the processing/prediction job indicated by the configuration will provide a suitably timely result. Where a specified job cannot be processes with sufficient lead time for the value of the predictive concept to be put to use, the configuration file may be declared invalid. According to certain embodiments, the configuration may also comprise data regarding the history of one or more predictive models associated with the prediction job, so that the evolution of the predictive models can be tracked, and prior, higher-performing iterations of the predictive model can be restored, should subsequent training on later-obtained data decrease the predictive performance of the model(s).

At block 513, production layer 501 performs a determination as to whether to perform a learning operation (for example, training one or more deep learning models implements at consumption layer 505) or a forecasting operation. Alternatively, in some embodiments, such as described in FIG. 5, method 500 may include performing both a learning operation and a forecasting operation (simultaneously or one after another).

Where, at block 513, method 500 follows the “learn” branch, operation proceeds to block 515, wherein distributed messaging system 503 queues a message for a pull of data required for further training of one or more deep learning models. According to certain embodiments, the message for the data pull comprises a message to an instance of a data mapper module (for example, data mapper 405 in FIG. 4) to pull data specified in a configuration file. In the running example, where a platform (for example, platform 400 in FIG. 4) is generating a control output for an order of cooking oil, the training data in the data pull queued at block 515 may include data showing sales and exogenous factors (for example, temperature, weather, temporal proximity to holidays, demographic information of one or more nodes of the network, ongoing promotions) causally or latently related to a value of a predictive concept. In some embodiments, the “learn” branch of method 500 is performed on a bi-weekly or monthly basis, while the “forecast” branch is performed daily.

According to various embodiments, at block 517, consumption layer 505 obtains the training data specified by the queued data pull request. Depending on embodiments, the data may be retrieved from a plurality of data sources, such as a database or set of databases (for example, database 497 in FIG. 4) that may include a set of storage containers and connectors defining operations for writing to and reading from, the storage containers. In some embodiments, the data pull is pulled from production layer 501.

Once the training data is received at consumption layer 505, at block 519, the training data is dumped into a worker 507 within an instance of a processing container. According to various embodiments, the training data as provided to worker 507 may not be properly formatted. For example, in some embodiments, instances of the same data (for example, units sold) maintained in different data stores may be mapped to different key values or expressed in different units. At block 521, the training data is reformatted to a common schema, with common key names for instances of the same underlying data values. According to some embodiments, at block 521, the data is formatted according to the classifications used by the deep learning model to be trained, which may not necessarily track the classifications used in collecting and storing the data. At block 521, the dumped training data is formatted as time-series data mapped to the inputs of the deep learning model to be trained.

According to various embodiments, at block 523, the worker sends an acknowledgement message to DMS 503 indicating that the data pull queued at block 515 is complete. As noted elsewhere in this disclosure, in certain embodiments, each processing container instantiated at consumption layer 505 can support multiple workers, and further instances or operations of method 500 performed by consumption layer 505 and worker 507 may be performed in parallel by other workers in a given container or within consumption layer 505.

At block 525, the model(s) to be trained or retrained as part of the cycle of operations in the “Learn” branch of method 500 are parsed, and the inputs and outputs of the model identified for implementation of a gradient descent-based tuning of weights of the connections between neurons of the deep learning model at block 531. As shown in the illustrative example of FIG. 5, at block 527, DMS 503 queues a model training request, which will be passed to consumption layer 505 upon satisfaction of a predetermined condition, such as receipt of an acknowledgment message from another worker indicating that a learning or prediction job is complete, and the worker is ready to process a further job. At operation 529, upon satisfaction of the predetermined condition, DMS 503 passes the training request to consumption layer 505, which picks up the training request and passes it to worker 507.

At block 531, a deep learning model is trained using a gradient descent method, wherein worker 507 iterates through the training received and formatted by worker 507, incrementally adjusting the weights of the connections between the constituent neurons of the network to minimize the value of a cost function defining a difference between the actual values of items in the training data set and the values predicted by the model. At each iteration, the gradient (or derivative, or slope) of the cost function relative to weight is calculated, and a minimum of the cost function can be found. Depending on the available time and computational resources, this process is iterated across each of the weighted connections between the neurons of the deep learning model. Depending on a number of factors, including without limitation, the size of the training data set and the depth of the deep learning models (i.e., the number of weighted connections between neurons of the model) block 531 can be computationally expensive.

At block 533, when the gradients of the cost functions have, to the extent possible, been minimized at block 531, the retrained deep learning model is saved by worker 507 for later use in a forecasting operation, and at block 535, an acknowledgement message is passed form worker 507 to DMS 503, indicating that worker 507 has completed training and saving the deep learning model on the training data set specified by the configuration file, and is available to take on a further job.

As shown in FIG. 5, upon completion of the “Learn” branch of decision block 513 (e.g., blocks 515 through 535), operation may proceed to the “Forecast” branch, wherein at block 537, DMS 503 queues a data pull for a forecasting operation to determine a predicted value of a parameter (for example, a number of pieces of chicken to be sold at a particular store location on a particular date) based on a subset of the available data, referred to in this example as “Forecast data.” At block 539, DMS 503 passes the request for the forecast data pull to consumption layer 505, and at block 541, the forecast data is dumped onto worker 507. According to certain embodiments, the data as provided at block 541 may, for a number of possible reasons, such as being stored in a database according to a schema which does not map to the fields or classifications used by the input layer of the trained deep learning model. At block 543, the forecast data is formatted to define a set of inputs having an initial value for each neuron of the input layer of deep learning model trained at block 531.

According to various embodiments, at block 545, worker 507 passes an acknowledgement message to DMS 503 indicating that the receipt and initial formatting of the forecast data by worker 507 is complete, and that worker 507 is ready to take on a further job request.

As shown in the explanatory example of FIG. 5, at block 547, production layer 501 parses the forecast data to recognize levels and entities within the data. According to certain embodiments, the parsing performed at block 547 is conceptually analogous to the parsing of data performed in certain deep learning model-based language processing, where elements within an input are, prior to being passed to the deep learning model, parsed to identify relevant structures (for example, verbs and nouns) within the input. By the same token, at block 547, the formatted forecast data is parsed to identify analytically relevant structures (for example, a shared sales area) within the forecast data. According to various embodiments, the operations of block 547 may be performed by a parser or clustering algorithm.

At block 549, with the forecast data formatted and parsed, it is ready to be passed to an instance of the trained deep learning model implemented by an available worker, and DMS 503 queues a job request for generating a forecast based on the forecast data. At block 551, the queued job request is picked up by consumption layer 505, and at block 553, the forecast data is passed to an instance of the deep learning model trained and saved at blocks 531 and 533 to generate a forecast of one or more values of predictive parameter(s) (for example, a number of pieces of chicken to be sold at a given store on a given date) from which a value of a predictive concept can be determined. At block 555, the forecast value(s) are saved by worker 507, and an acknowledgement message indicating that worker 507 has completed the forecasting job is sent to DMS 503 at block 557.

At block 559, one or more modules of production layer 501 determine a value of a predictive concept based on the forecast generated at block 553. In this way, processing architectures for implementing method 500 provide practical, real-world gains in efficiency, configurability and speed by splitting the algorithmic and deep learning components of generating a value of a predictive concept across two separate computing layers. In this way, predictive concepts which can be determined at much less computational cost through algorithmic manipulation of a forecasted output of a deep learning model can themselves be predicted without the computational and time costs of training separate models for each predictive concept of interest. Further, by interposing DMS 503 as a central broker for queuing and transmitting job requests, data pulls, and operations of the consumption layer, the problem of developing separate APIs or otherwise directly interfacing the components of the production layer with the components of the consumption layer is avoided, thereby making the platform more extensible and flexible.

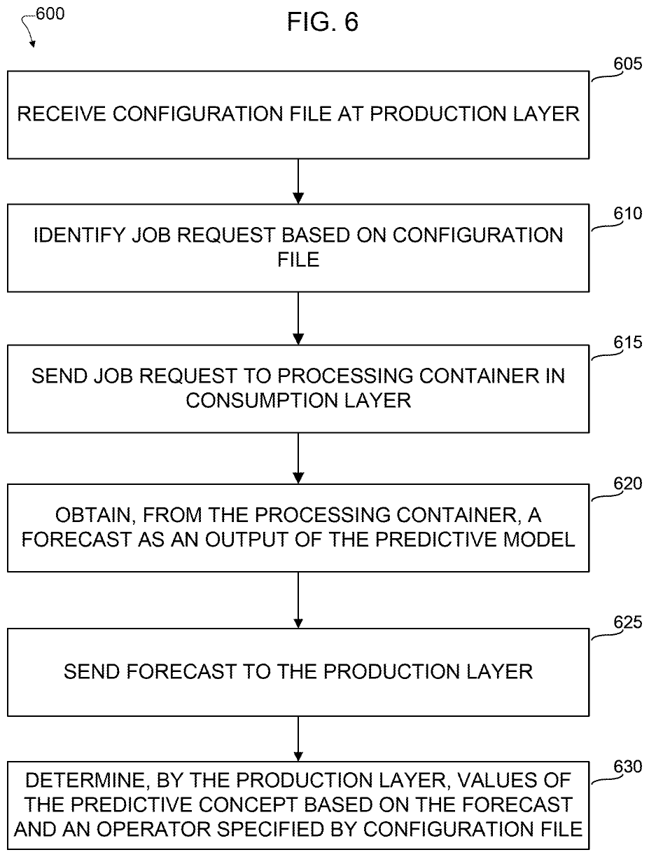

FIG. 6 illustrates steps of an example method 600 for performing parallel predictive modelling according to various embodiments of this disclosure. The operations described with reference to FIG. 6 may be performed at any suitably configured computing platform, including, without limitation, server 200 in FIG. 2, platform 305 in FIG. 3, or a computing platform including production layer 501, DMS 503, consumption layer 505 and one or more instances of worker 507 in FIG. 5.

Referring to the non-limiting example of FIG. 6, at step 605, a configuration file (for example, the configuration file opened at block 509 in FIG. 5) is received at a production layer (for example, production layer 401 in FIG. 4) of a computing platform. In this example, the configuration is associated with a predictive concept—wherein determining a value of the predictive concept (for example, a future cooking oil requirement for a node of a large restaurant) has a computationally expensive component requiring the use of a deep learning model trained on a large corpus of historical data to obtain a value of a forecasted parameter, and a component which can be determined computationally efficiently and algorithmically, through a set of rules based operators applied to the value of the forecasted parameter. According to various embodiments, the configuration file received at step 605 may specify some, or all, of the user-tunable parameters for obtaining the value of the predictive concept, including, without limitation, the forecast data set, the deep learning model(s) to be used at the consumption layer, and the operators, or components of a module (for example, components 405-407 of first module 403 in FIG. 4) used to perform the algorithmic component of determining the value of the predictive concept.

At step 605, the production layer identifies a job request based on the configuration file. According to various embodiments, step 605 includes identifying whether the configuration request specifies a learning job (for example, the “Learn” branch of decision block 513 in FIG. 5), a forecasting job (for example, the “Forecast” branch of decision block 513 in FIG. 5). In some embodiments, identifying the job request further includes identifying constituent steps of the job request, such as a pull (for example, the forecast data pull queued and executed at blocks 537 and 539 of FIG. 5) of data for a forecasting or training operation.

At step 615, the job request is sent from the production layer to a processing container (or, in embodiments where a single container is parallel processing multiple job requests, a worker within a processing container). In some embodiments, the job request may be passed directly from the production layer to the consumption layer. In certain embodiments, the job request may be passed indirectly, or in multiple steps involving an intermediate platform entity (for example, DMS 503 in FIG. 5).

At step 620, a forecast including one or more values of forecasted parameters is obtained by passing the forecast data specified in the configuration file to one or more deep learning models implemented in a container of the consumption layer. According to various embodiments, step 620 further includes sending an acknowledgement (for example, the acknowledgement shown by block 557 in FIG. 5) to the distributed messaging system that the forecasting job is complete. At step 625, the forecast is passed from the consumption layer to the production layer.

As discussed elsewhere in this disclosure, certain embodiments according to the present disclosure catalyze efficiency, flexibility and extensibility gains for practical, real-world implementations of deep learning based predictive modelling by splitting the generation of values of predictive concepts across two separate processing layers, wherein the production layer handles the first and last miles of generating the value(s) of the predictive concept. At step 630, the “last mile” or processing to generate the value(s) of the predictive concept are performed, wherein a module (for example, first module 403 in FIG. 4) applies one or more operators (for example, modules 405-409 in FIG. 4) to the forecast sent at step 625 to obtain a value of the predictive concept specified in the configuration file initially received at the production layer in step 605.

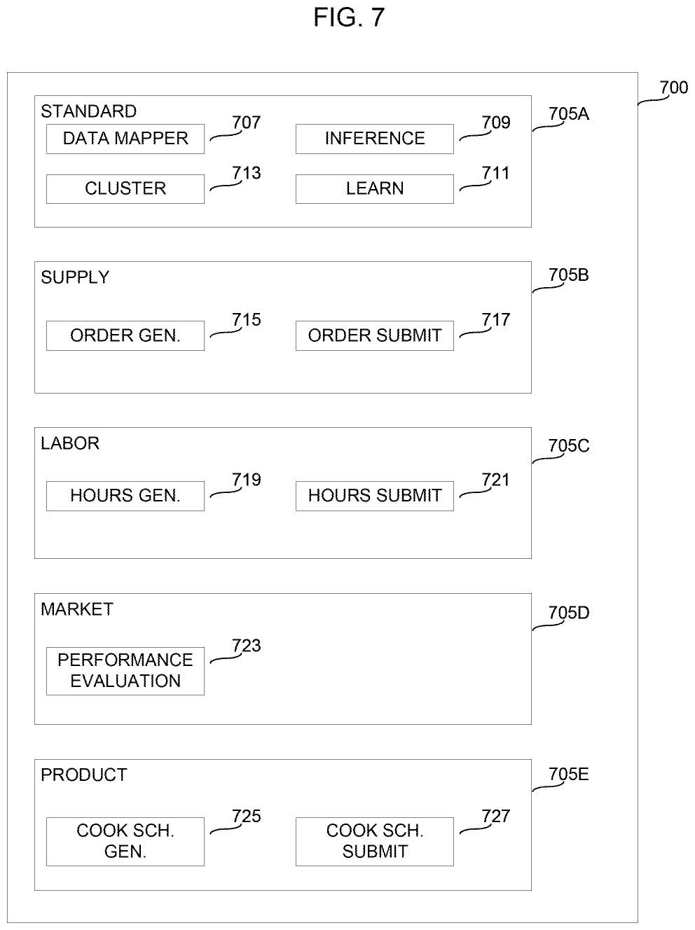

FIG. 7 illustrates an example of different modules implemented in a production layer 700 of a predictive modelling platform (for example, platform 400 in FIG. 4) according to various embodiments of this disclosure.

The production layer 700 may be implemented on a variety of possible computing platforms which are communicatively connected to a consumption layer, a distributed messaging system (for example, DMS 475 in FIG. 4), and one or more data stores (for example, database 497 in FIG. 4). Examples of computing platforms on which production layer 700 may be implemented include, without limitation, one or more servers (for example, server 200 in FIG. 2), or a cloud computing platform.

In the example of FIG. 7, production layer 700 is implemented as part of a predictive modelling platform for a chain of restaurants. Recalling the example of FIG. 3, the nodes of the network from which the predictive modelling platform receives data and outputs predictions and control outputs through production layer 700 may be restaurants within the chain or other points of sale (and the secondary nodes may be terminals within each restaurant). Further, the predictive modelling platform providing production layer 700 may further be connected to one or more external systems 325 which either receive control inputs from the predictive modelling platform, or provide data associated consumed by either production layer 700. For example, in embodiments where the nodes of the network are restaurants within a chain, external systems 325 may comprise an ordering system for

As discussed elsewhere in this disclosure, in certain embodiments, production layer 700 embodies a modular architecture in which software building blocks can be combined to modules for obtaining specified outputs in response to providing current or predicted values of features used by deep learning models implemented at the consumption layer. In the example of FIG. 7, production layer 700 comprises five modules 705A-705E for generating prediction based associated with the operation of a restaurant chain having a plurality of locations. In this example, the modules include a supply module 705B, which generates and submits (for example, to the APIs of third-party vendors) orders for restaurant supplies for specific restaurants within the chain based on forecasted values of predictive variables. Also included is a labor module 705C which generates and submits shift schedules for specific restaurants in a network based on forecasted values of predictive variables. The production layer 700 also includes a marketing module 705D and a product module 705E. The marketing module 705D is configured to support marketing research and testing to determine the effect, if any, a marketing campaign or implemented change at one or more restaurant locations. As noted elsewhere in this disclosure production layer 700 implements a modular architecture, and, in this example, each of modules 705B-705E are built on top of a standard module 705A.

Referring to the illustrative example of FIG. 7, standard module 705A includes software components for defining jobs to be passed to the consumption layer as well as the software tools for assembling and, where necessary, formatting data comprising present or predicted values of features of deep learning model(s) implemented at the consumption layer. According to various embodiments, standard module 705A contains one or more instances of a data mapper 707 (for example, data mapper 405 in FIG. 4), which is configured to post and fetch data maintained across a variety of databases according to various schema. In the example of FIG. 7, the schema for the data used by the predictive modelling platform may include various tables and data types, including those shown in Table 1, below:

TABLE 1

| Table | Types of Data Maintained in Table |
|---|---|
| Store Data | Data Values of a Specific Store Location |
| | Store ID (integer), Region ID (integer), Address (Text), Drive Through? |
| | (Boolean) |
| Service Data | Data Values Obtained as a Service or From Third Parties |
| | Predicted temperature (integer), demographic information (text, integer), |
| | Special Event (Boolean) |
| Product Data | Data Values of Products Sold by Restaurant |
| | Product ID (integer), Region ID (integer), Product Name (text), Product |
| | description (text), Parent Item ID (integer) |
| Menu Data | Data Values of Menus at Restaurant Locations |
| | Menu ID (integer), Store ID (integer), Product ID (integer) |
| Calendar/ | Data Values of Store and Business Calendar |
| Schedule Data | Calendar ID (integer), Store ID, Franchise Week Start (Timestamp), |
| | Franchise Weekend (Timestamp) |
| Performance/ | Data Values Showing Sales and Performance of Individual Locations |
| Transaction Data | Transaction ID (integer), Product ID(s) (integer), Store ID (integer), |
| | quantity (integer), Gross Sales (Float), Transaction ID (timestamp) |
| Campaign Data | Data Values Pertaining to Marketing/Advertising or other Promotional |
| | Campaigns |
| | Campaign ID (integer), Region ID (integer), Campaign Name (text), Start |
| | Date (timestamp), End Date (timestamp), Is Active? (boolean), Campaign |
| | Products (variant), Test Stores (variant), Control Stores (variant) |
| Supply Order | Data Values Pertaining to Supply Orders for Specific Locations |
| Data | Store ID (integer), Distributor ID (integer), Order Date (Timestamp), Order |
| | Items (variant) |
| Inventory Data | Data Values Pertaining to Items in Inventory for Specific Locations |
| | Item ID (integer), Unit count (float), Recipe (boolean or integer), |
| | Description (text) |
| Recipe Data | Data Values Pertaining to Recipes Implemented at Locations |
| | Region ID (integer), Recipe ID (integer), Name (string), Description |
| | (string), Quantity (float) |
| Constraint Data | Data Values Pertaining to Constraints (for example, expiration dates, |
| | minimum quantity) |
| | Buffer ID (integer), Region ID (integer), Store ID (integer), Days (integer), |
| | Inventory ID (Integer) |

As indicated by Table 1 above, predictive modelling platforms according to various embodiments of this disclosure may, in certain embodiments, utilize enormous amounts of data. Further, as shown above, data mapper 707 may be configured to implement a variety of database options (for example, joins and merges) associated with fetching data for generating a particular output.

Standard module 705A may further include an inference module 709, which defines the parameters of a configuration file (for example, the configuration file validated at block 511 in FIG. 5). Recalling the example of FIG. 5, certain embodiments according to the present disclosure implement a configuration driven design, wherein the parameters of specific forecasting and control tasks implemented by the predictive modelling platform are defined through configuration files passed between the distributed messaging system, the consumption layer and production layer 700, inference module 709 may validate and/or define the parameters of a configuration for an output based on an inference from a forecast value of a parameter of interest. As one illustrative example, where the volume of soft drinks to be ordered at a particular restaurant data depends on the predicted value of a related variable (for example, a number of units of chicken to be sold), inference module 709 may confirm that the configuration file accurately specifies which model to be implemented at the consumption layer, and that the data to be provided to the consumption layer matches the features used by the model. Similarly, learning module 711 performs a corresponding validation/definition functionality for operations training one or more models implemented at a consumption layer.

According to various embodiments, standard module 705A further comprises one or more clustering modules 713 configured to define sets of analogous elements (for example, restaurants of similar size, volume and location features to form a test or control group for a marketing experiments) for aggregative analyses.

As shown in the supply module 705B is configured to generate prediction and inventory-based orders and submits them to one or more distributors. As skilled artisans will appreciate, managing inventory for a specific restaurant is a multi-pronged challenge, with potential negative consequences to restaurant owners associated with ordering excess inventory (i.e., perishable supplies go unsold), and ordering insufficient inventory (i.e., lost sales due to lack of supplies, resulting in a loss of customers). The challenges associated with tuning supply orders for a restaurant are further heightened by the fact that orders need to be placed on a rolling, daily or semi daily basis 1-3 days ahead of time, and restaurant locations also need to maintain buffer stocks of supply to cover the possibilities of either supply deliveries being delayed or unexpected surges in demand.

According to various embodiments, supply module 705B generates, for each store within a network of chain restaurants, a forecasted supply order based on the restaurant's expected supply needs 48-72 hours in the future. Depending on embodiments, supply module 705B may perform a supply order analysis once every 12-24 hours and may re-train the deep learning model(s) providing values of predictive variables every 14-28 days.

In certain embodiments, an order generation module 715 validates a configuration file received at for a scheduled order at a restaurant. The configuration file may specify the types and time range of data to be provided to a deep learning-based forecasting model implemented at the consumption layer. In some embodiments, the data provided as features for the deep learning model may include store data, service data, historical service data (to identify trending sales), menu data, inventory data and recipe data. Depending on embodiments, one or more values of the data provided as features is based on previously calculated predicted values (for example, a change in each supply based on the forecasted demand in the next 24 hours). Further, depending on embodiments, to smooth out the effects of random, store-to-store variations, some of the values of data provided to the order generation module may be based on aggregates of data from stores clustered by clustering module 713 (for example, a group of similarly performing stores in an equivalent geographic area).

According to various embodiments, the data corresponding to the historical and/or predicted values of features of the deep learning model(s) implemented at the consumption layer is passed to the consumption layer, which returns values of one or more predictive variables for a specified time period. For example, for a chain of fried chicken restaurants, the consumption layer may return a forecasted value for the number of pieces of chicken expected to be ordered 48-72 hours in the future, which is a reliable proxy for the overall demand for related supplies. According to various embodiments, order generation module 715 determines, based on the predicted value(s) of one or more proxies for overall demand, the demand for other items in inventory, based on current stock and operational constraints (for example, expiration dates, and the need to maintain buffer stock to guard against shipping delays and spikes in demand). Depending on the frequency with which the underlying models in the consumption layer are updated, the determination of an adequate buffer stock may be performed dynamically and adapted to the current conditions at the store. For example, where the forecasted demand over a given interval is low, order generation module 715 may be configured to “thin” the contents of the existing buffer in response to an increased likelihood of the buffer supplies expiring, rather than being sold. Additionally, while in some embodiments, the existing stock and supplies on hand at a given node at a given time may be provided to the consumption layer as input data, in certain embodiments, the current stock and supplies on hand may be inferred by the model for times in between times in which recorded inventory data is provided by a node (for example, by taking an inventory check) to the consumption layer. In this way, order generation module 715 can dynamically and adaptively place orders for supplies at times in between inventory measurements.

According to certain embodiments, order generation module 715 generates, for each restaurant in the chain, a predicted order and sends same to the restaurant, which can modify or adjust the order to reflect the proprietor's judgment or information beyond that provided to the predicted module (for example, a local event sufficient to significantly drive demand, such as a youth sports tournament, but not likely to be captured in the data stream provided to the predictive modelling platform) before the order is passed to an order submission module 717, which connects with interfaces (for example, APIs) of one or more distributors and suppliers to place the generated supply order.

The labor module 705C is configured to generate, for restaurants within a network of restaurants, a staffing schedule. Skilled artisans will appreciate that forecasting staffing requirements for a particular location is, like forecasting requirements for supplies, is largely dependent on forecasted demand at the restaurant. However, generating forecasts of staffing requirements may require managing more constraints (for example, differences in skill and experience between team members mean that not every employee can fulfill every role), efficiency variances (for example, less experienced cooks have lower throughput), and greater time granularity (i.e., staffing demands may be more time dependent, with surges of demand in particular time slots), than forecasting supplies. Put differently, food overstocks may be sold the next day, while overstaffing a restaurant causes immediate losses.

According to various embodiments, an hours generation module 719 generates or validates a configuration file for a restaurant of a chain of restaurants for a future date (for example, a week in advance, as employees are typically not “on call”) on a rolling, daily basis. The configuration file specifies data corresponding to future or historical (for example, where a deep learning model looks for trends in the data) values of features from which a value of variable strongly correlated with labor demand (for example, number of units of a core menu item, such as hamburgers or fried chicken) can be predicted. In certain embodiments, the data corresponding to features of the deep learning model includes store ID data, performance/transaction data, product data and service data (for example, data indicating whether a forecasted date is associated with a demand-altering event, such as Christmas Day). This is data is provided to one or more deep learning models implemented on the consumption layer, which provides forecasted values of one or more items strongly correlated with labor demand.

As discussed elsewhere in this disclosure, certain embodiments bifurcate the computational tasks associated with generating outputs between the consumption layer, which is tasked with performing the computationally expensive processes of training and implementing deep learning models, and the algorithmic, readily reconfigurable tasks are performed at production layer 700. Accordingly, the hours generation module 719 applies the item forecast(s) generated at the consumption layer to a scheduling algorithm, which generates a schedule based on the item forecasts, and the known or predicted variables affecting scheduling constraints. Variables affecting scheduling constraints include, without limitation, employee availability, store hours, maximum hours, employee ratings (for example, ratings of employee experience or efficiency), employee job title (as a proxy for which store roles can be fulfilled by a particular employee), baseline staffing requirements (for example, a requirement that a manager be present during business hours).

According to certain embodiments, the hours generation module 719 sends a generated schedule to the store as part of a user interface by which the store can update or revise the schedule based on the store manager's understanding of her forecasted labor requirements and local constraints not known to the predictive modelling platform. The revised labor schedule is provided to an hours submission module 721, which publishes the schedule (for example, to scheduled workers' personal devices) and passes the stored schedule to data mapper 707 for storage and use as training data.

Referring again to FIG. 7, the market research module 705D in configured to generate predictive outputs for analyzing the performance of marketing campaigns. As skilled artisans will appreciate, the challenges associated with measuring the success or efficacy of a marketing campaign include, without limitation, defining test and control groups, and validating the performance of the test groups. More specifically, identifying a set of stores that, to the greatest extent possible, will exhibit performance differentials based on the presence or absence of a tested variable (for example, the presence of a new menu item) is a first layer of technical challenge. Disaggregating the effects of single-location events during a test period presents a further layer of challenges. For example, consider the case where the marketing campaign concerns the introduction of a new ice cream product, and a small subset of restaurants in the test group experience unseasonably cold weather. All other things being equal, sales of the new ice cream product will be depressed, albeit for reasons completely unrelated to the tested parameter—whether and how much customers like and demand the new ice cream product.

According to various embodiments, a performance evaluation module 723 addresses the above-described problems in at least the following ways: 1) by clustering analytically analogous stores together to form test and control groups; and 2) by generating predictions of “but for” performance of stores in the control/test groups to mitigate the effects of “black swan events” and other localized variances in sales performance.

According to various embodiments, the performance evaluation module 723 calls clustering module 713 to identify a first cluster of restaurants to serve as a test group of restaurants for a market study, and a second cluster of restaurants to serve as a control group of restaurants for the market study. In some embodiments, clustering module 713 aggregates restaurant locations based on multiple dimensions of data. The dimensions of data for clustering may include, for example, geographic data, demographic data, historical performance data, and menu data (to ensure that customers are selecting the tested item from an equivalent pool of alternatives). According to various embodiments, the clustering module 713 may implement one or more of a K-means, a means-shift, or an agglomerative hierarchical clustering algorithm to define test and control groups.

Skilled artisans will appreciate that while it is preferable to run market tests for as long as possible, in order to get as full of a data set as to the demand for new products or restaurant changes, this is not always possible, and market research may need to be conducted over shortened timescales, where the effects of intervening events can make determination of the effects of the tested product or change harder to measure. Accordingly, to “smooth” out the data and minimize the effects of localized variations on the data recorded from a particular store, certain embodiments may perform a predictive analysis of the sales performance at a given location to establish a baseline or expected value as to what the sales would have been, but for the occurrence of the unexpected event. According to various embodiments, performance evaluation module 723 either generates or validates a configuration file to obtain an item-level forecast of sales for a particular location. Depending on embodiments, the configuration file specifies data comprising present or predicted values of features of one or more deep learning models which output values of variables (for example, items of a core menu item, such as hamburgers at a hamburger stand, or pieces of chicken at a fried chicken restaurant) which operators of performance evaluation module 723 can generate item-level sales forecasts. Examples of data which may be passed to the one or more deep learning models include, without limitation, store data, service data, product data, menu data, performance/transaction data, campaign data and recipe data.

The product module 705E is configured to generate a demand-based cooking schedule for each restaurant within a chain of restaurants. Skilled artisans will appreciate that preparing a cooking schedule presents a number of challenges and issues to be balanced. In addition to managing bandwidth challenges (for example, a single cook can only keep an eye on so many items), recency requirements (i.e., not all foods can be pre-prepared equally in advance of an expected serving time), preparing a cooking schedule involves a variety of other constraints and dimensions for optimization (for example, trying to use up ingredients closest to their expiration dates).

According to various embodiments, a cooking schedule generator 725 generates an item-level forecast of the current day's cooking demand and prepares a schedule of cooking tasks based on the demand. In contrast to certain other modules of production layer 700, cooking schedule generator 725 generates forecasts for periods closer to the present, albeit with potentially more local constraints.

To generate an item-level forecast of a current day's cooking demand, cooking schedule generator 725 generates or validates a configuration file specifying the data types associated with features of one or more deep learning models which provide values of predictive variables from which an item-level forecast of the day's cooking demands can be generated. According to various embodiments, the data types mapping to features of the deep learning model include, without limitation, Examples of data which may be passed to the one or more deep learning models include, without limitation, store data, service data, product data, menu data, performance/transaction data, campaign data and recipe data.

According to various embodiments, the data corresponding to present or forecasted values of the predictive variables are passed to one or more deep learning model(s) at the consumption layer, which returns forecasted values of one or more variables (for example, units of a staple, core, or labor-intensive menu item) which are predictive of the day's cooking load. The cooking schedule generator 725 may also apply the forecasted values of the predictive variables, along with localized data (for example, inventory and staffing data) to generate a cooking schedule for the day.

According to various embodiments, after generating a cooking schedule specifying items to be cooked and a suggested timed cooking sequence, the cooking schedule may be published (for example, as an email to a restaurant manager) for review and approval. As with other modules of production layer 700, cooking schedule generator 725 is designed in the expectation that local personnel may possess demand and/or capability related information (for example, information regarding a series of short-notice employee absences) not yet available to the predictive modelling platform. In some embodiments, cooking schedule generator 725 may, in addition to generating a cooking schedule specifying items to be cooked, further specify a recommended schedule of ancillary tasks, such as kitchen prep tasks (for example, thawing items, chopping ingredients, or the like).

When the generated cooking schedule has been approved (or no revision action has been taken within a specified time), it passes to a cooking schedule submission module 727, which submits and publishes the determined cooking schedule (for example, to terminals of an order management system in the kitchen of the restaurant).

FIG. 7 is intended to be illustrative, rather than limitative of, the modules which a production layer 700 according to various embodiments may comprise. In some embodiments, production layer 700 may comprise one or more modules configured to provide real-time actions or suggestions to operators of a restaurant. The real-time actions and/or suggestions may be based on a combination of conditions predicted by the output of the consumption layer and real-time data. Examples of such real-time actions may include, for example, a reminder to the operator of a fried chicken restaurant to change the oil in a fryer based on a combination of predicted demand and measured temperature (thereby keeping the oil from going rancid through a combination of heavy use and sustained heating).

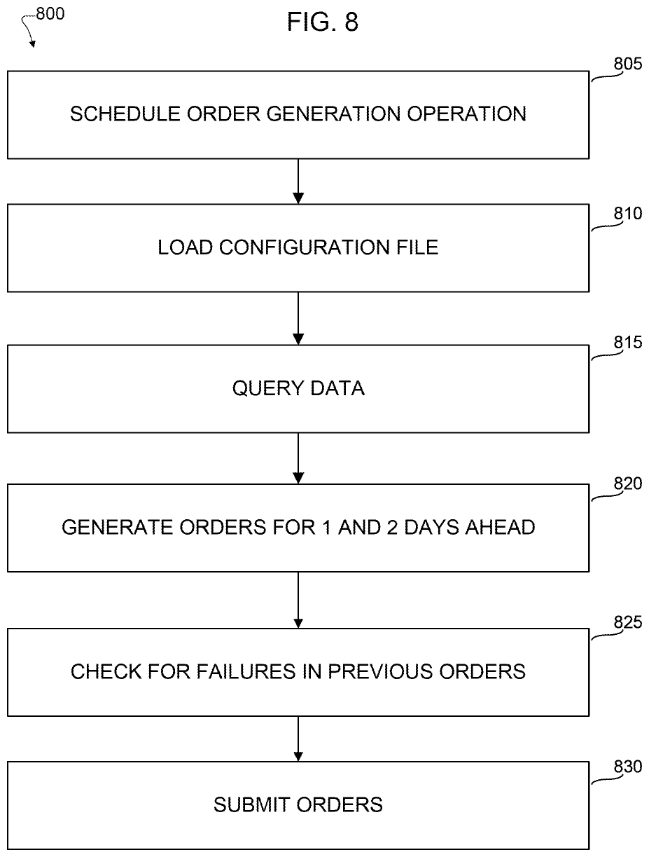

FIG. 8 illustrates operations of an example method 800 for generating a supply order for a specific restaurant at a predictive modelling platform (for example, predictive modelling platform 400 in FIG. 4) according to various embodiments of this disclosure.

At operation 805, an order generation operation for a specific restaurant is scheduled. According to various embodiments, the operation is scheduled by a scheduler or configuration manager (for example, configuration manager 499 in FIG. 4), and operation 805 comprises setting the parameters of the configuration file. Setting the parameters of the configuration file may include identifying the types of data to be provided to the consumption layer, the deep learning models of the consumption layer to be utilized, as well as the modules (for example, supply module 705B in FIG. 7) of the production layer for building an order from the outputs of the consumption layer, as well as additional data required by the consumption layer.

In this example, the end output to be obtained from the predictive modelling platform is an order for supplies for the restaurant based on forecasted demand and local constraints. One or more deep learning models of the consumption layer are provided with present or predicted values (for example, forecasted temperatures) of data corresponding to features of the deep learning model(s), and the deep learning modules return one or more forecasted values of variables that correlate to predicted demand at the restaurant. For example, the data comprising features of the deep learning module may include, forecasted weather, day of the week, moving averages of current sales for the restaurant location, and data showing demand across a cluster of restaurants to which the modeled restaurant belongs. The deep learning module returns a forecasted value of one or more variables that is strongly correlated to demand for all of the supplies of the restaurant. For example, if the restaurant is a hot dog restaurant, the forecasted variable may be a number of hot dogs forecasted to be sold. In this example, the demand for all of the restaurant's supplies are, if not proportional to, then at least linked to the predicted demand for hot dogs. The production layer takes the forecasted value of the correlated variable, and using local information (for example, current inventory data) and rules (for example, each hot dog requires a bun, and is sold with 0.75 soft drinks) to determine the predicted consumption of all of the restaurant supplies. From this, a series of orders at multiple time offsets (for example, 24 and 48 hours into the future) are generated.

According to some embodiments, at operation 810, a configuration file is, according to the schedule set at operation 805, passed by a distributed messaging system (for example, distributed messaging system 475 in FIG. 4 to a designated module of the production layer (for example, supply module 705B in FIG. 7), which loads and validates the configuration file, initiating the process of obtaining forecasted value(s) of one or more correlated variables (for example, a number of units of a core menu item, such as hot dogs or pieces of fried chicken).

At operation 815, a module, or sub module (for example, data mapper 707 in FIG. 7) queries, or pulls the data specified in the configuration file. According to various embodiments, the data pulled at operation 815 includes both the data used by the consumption layer to be provided to one or more deep learning models to obtain forecasted value(s) of correlated parameters, as well as the data used by the production layer (for example, current inventory, expiration data on current inventory, weather-related supply constraints, etc.) to build orders for the restaurant location based on the forecasted values provided by the consumption layer.

At operation 820, the predictive modelling platform generates a set of two orders: a first order to be placed one day in the future and a second order to be placed two days in the future. As discussed elsewhere, the order is generated by first obtaining one or more forecasted values of a variable correlated with overall demand at the particular restaurant location at the consumption layer, and then applying operators at a supply module of the production layer to determine, based on overall demand, and the status of a current inventory at the store location, the items to be placed in the first and second orders.

As shown in FIG. 8, at operation 825, the production layer queries a data store (for example, a computer system of the restaurant for which orders are being generated, or a central data store, such as database 497 in FIG. 4) to determine if any previously placed orders have failed. Where, at operation 825, the production layer determines that a previously placed order has failed, the orders generated at operation 820 are updated to offset the effect of the failed order.

According to various embodiments, at operation 830, the orders are submitted to one or more distributor's order systems, and logged within the data store of the predictive modelling platform.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method for parallel predictive modelling, the method comprising:
receiving a configuration file associated with a predictive concept at a production layer of a predictive modelling platform, the predictive modelling platform comprising the production layer and a consumption layer, wherein the production layer and the consumption layer are communicatively connected by a distributed messaging system;
identifying, by the production layer, a job request based on the configuration file;
sending, by the distributed messaging system, the job request to the consumption layer, as one of a plurality of job requests to be passed to a predictive model implemented by a processing container, wherein the predictive model is specified by the configuration file;
obtaining, from the processing container, a forecast as an output of the predictive model;
sending, by the distributed messaging system, the forecast to the production layer; and
determining, by the production layer, one or more values of the predictive concept based on the forecast and an operator specified by the configuration file.

2. The method of claim 1, wherein the predictive model is a deep learning model.

3. The method of claim 1, further comprising:
identifying, by the production layer, a model training request based on the configuration file;
sending, by the distributed messaging system, to the consumption layer, a request for updated training data from a data mapper provided by the predictive modelling platform; and
training the predictive model based on the updated training data.

4. The method of claim 3, wherein the configuration file comprises a history of predictive models used to generate the one or more values of the predictive concept.

5. The method of claim 3, wherein the data mapper comprises a data store for the predictive modelling platform, and
wherein the data mapper assigns a plurality of connections between a plurality of heterogeneous data storage units.

6. The method of claim 1, wherein the configuration file specifies a feature set for the predictive model used to generate the one or more values of the predictive concept.

7. The method of claim 1, further comprising:
generating, by the production layer, a control command comprising a parameter based on the determined one or more values of the predictive concept; and
sending the control command, via a network to an external system.

8. A platform, comprising:
a processor; and
a non-transitory memory containing instructions, which, when executed by the processor, cause the platform to:
receive a configuration file associated with a predictive concept at a production layer of the platform, wherein the platform comprises the production layer and a consumption layer, wherein the production layer and the consumption layer are communicatively connected by a distributed messaging system,
identify, by the production layer, a job request based on the configuration file,
send, by the distributed messaging system, the job request to the consumption layer, as one of a plurality of job requests to be passed to a predictive model implemented by a processing container, wherein the predictive model is specified by the configuration file,
obtain, from the processing container, a forecast as an output of the predictive model,
send, by the distributed messaging system, the forecast to the production layer, and
determine, by the production layer, one or more values of the predictive concept based on the forecast and an operator specified by the configuration file.

9. The platform of claim 8, wherein the predictive model is a deep learning model.

10. The platform of claim 8, wherein the memory further contains instructions, which, when executed by the processor, cause the platform to:
identify, by the production layer, a model training request based on the configuration file,
send, by the distributed messaging system, to the consumption layer, a request for updated training data from a data mapper provided by the predictive modelling platform, and
train the predictive model based on the updated training data.

11. The platform of claim 10, wherein the configuration file comprises a history of predictive models used to generate the one or more values of the predictive concept.

12. The platform of claim 10, wherein the data mapper comprises a data store for the predictive modelling platform, and
wherein the data mapper assigns a plurality of connections between a plurality of heterogeneous data storage units.

13. The platform of claim 8, wherein the configuration file specifies a feature set for the predictive model used to generate the one or more values of the predictive concept.

14. The platform of claim 8, wherein the memory further comprises instructions, which when executed by the processor, cause the platform to:
generate, by the production layer, a control command comprising a parameter based on the determined one or more values of the predictive concept, and
send the control command, via a network to an external system.

15. A non-transitory, computer-readable medium containing instructions, which when executed by a processor, cause a predictive modelling platform to:
receive a configuration file associated with a predictive concept at a production layer of the platform, wherein the platform comprises the production layer and a consumption layer, wherein the production layer and the consumption layer are communicatively connected by a distributed messaging system,
identify, by the production layer, a job request based on the configuration file,
send, by the distributed messaging system, the job request to the consumption layer, as one of a plurality of job requests to be passed to a predictive model implemented by a processing container, wherein the predictive model is specified by the configuration file,
obtain, from the processing container, a forecast as an output of the predictive model,
send, by the distributed messaging system, the forecast to the production layer, and
determine, by the production layer, one or more values of the predictive concept based on the forecast and an operator specified by the configuration file.

16. The non-transitory, computer readable medium of claim 15, wherein the predictive model is a deep learning model.

17. The non-transitory, computer readable medium of claim 15, further comprising instructions, which when executed by the processor cause the predictive modelling platform to:
identify, by the production layer, a model training request based on the configuration file,
send, by the distributed messaging system, to the consumption layer, a request for updated training data from a data mapper provided by the predictive modelling platform, and
train the predictive model based on the updated training data.

18. The non-transitory, computer readable medium of claim 17, wherein the configuration file comprises a history of predictive models used to generate the one or more values of the predictive concept.

19. The non-transitory, computer readable medium of claim 17, wherein the data mapper comprises a data store for the predictive modelling platform, and
wherein the data mapper assigns a plurality of connections between a plurality of heterogeneous data storage units.

20. The non-transitory, computer readable medium of claim 17, wherein the configuration file specifies a feature set for the predictive model used to generate the one or more values of the predictive concept.
